(19) United States
(12) Patent Application Publication
(10) Pub. No.: US 2010/0304178 A1
(43) Pub. Date: Dec. 2, 2010

(54) CARRIER MATERIAL FOR PRODUCING WORKPIECES

(75) Inventor: Markus Dirscherl, Munchen (DE)

Correspondence Address: KOLISCH HARTWELL, P.C., 200 PACIFIC BUILDING, 520 SW YAMHILL STREET, PORTLAND, OR, 97204, US

(73) Assignee: HERMLE MASCHINENBAU GMBH, Gosheim (DE)

(21) Appl. No.: 12/596,135

(22) PCT Filed: Apr. 16, 2008
(86) PCT No.: PCT/EP08/03050

§ 371 Date: Mar. 4, 2010

(30) Foreign Application Priority Data
Apr. 16, 2007 (DE) 10 2007 017 754.4

(51) Int. Cl. B32B 5/18; B22F 3/02; B22F 1/00; B32B 15/18; B32B 15/20; B32B 15/01

(52) U.S. Cl. 428/613; 419/66; 419/38; 428/649; 428/615; 428/646; 428/674; 428/680; 428/681; 428/650; 428/658

(57) ABSTRACT

A carrier material to be used as a placeholder for structuring workpieces having at least one vacuity is disclosed, said carrier material comprising at least two metal powders Mel and Mell, the standard electrode potentials of which are different at room temperature, which can be produced by a method compacting the powders, as well as a method for producing same.

The invention relates to a method for producing a workpiece having at least one vacuity or any other portion which is not filled, and a carrier material suited for this purpose.

Workpieces with portions being not filled, such as cavities, recesses, notches, undercuts, openings etc., are generally referred to as “vacuity” in the following to simplify matters, wherein this term also includes spaces which are not completely surrounded by a wall, such as undercuts.

In a method suitable to produce complex shapes, layers are sprayed subsequently, which layers form the body. At those locations where a vacuity shall be generated in the final body, a material is used which can be removed after completing the body. In order to be able to use a material for such a method, it must be removable after completion of the body for forming the vacuity, wherein the removal must be simple and cost-effective.

Normally, a soluble material is used, which can be dissolved away after completion of the shape. The use of aqueous media, which are easily available and disposable, is therefore desired.

The dissolvable material used as a “placeholder” is also referred to as “lost core” or “lost mould”.

A material to be used for lost cores has to fulfil various requirements, i.e. it has to resist mechanical and thermal stress. These requirements are not fulfilled by the soluble salts desired to be used for the lost cores. Although salts are an interesting material in view of their solubility and availability, they cannot be used in methods with mechanical stress, such as thermal spraying, cold gas spraying or compacting, due to their brittleness. Due to their brittleness, the salts cannot resist the mechanical stress generated by those methods.

Therefore, another material has to be found for this case, which on the one hand can resist the mechanical stress during the production of the workpiece, but is on the other hand removable after completion without destroying the workpiece.

DE 19 716 524 proposed to provide a water-soluble core made of an aluminium or magnesium alloy for producing bodies having at least one cavity. It is a subject-matter of this application to use such magnesium or aluminium alloys, the oxide content of which is adjusted such that the mechanical strength is sufficiently high on the one hand and, on the other hand, the solubility is sufficient to dissolve away the core subsequently. For solving this object, it was necessary to use alloys and to add a high proportion of oxides to the alloys.

After completion of the mould, said alloy shall than be dissolved away with water or a acidic or basic solution. It was found out that this known material is not suited for all kinds of moulding methods.

It was now an object of the invention to provide a carrier material which can be moulded into any shape, which can be used for nearly any moulding method for shaping lost cores, which is removable after completion of the mould with a justifiable effort and substantially without damaging the mould, and the removal of which burdens the environment as little as possible. The material shall be removable even if very complicated or delicate shapes, e.g. narrow channels, are concerned.

In addition, it was an object of the invention to provide a material which can be processed also with thermal spraying methods, in particular kinetic spraying or cold gas spraying, i.e. which is sufficiently resistant to mechanical stress and easily available.

These objects are solved by a carrier material which can be used as a placeholder when structuring workpieces having at least one vacuity, which comprises a compacted corrodible material, wherein the corrodible material is a mixture or an alloy made of at least two metals, Mel and Mell, the standard electrode potential of Mell being smaller than that of Mel under reaction conditions.

The inventive compacted carrier material comprises preferably at least one metal Mell which is corrodible upon contact with a corroding medium under defined conditions by 35%, preferably at least 55% and particularly preferred by at least 70% within a time period of 30 minutes to 10 hours. The removal of the less precious metal Mell depends on the geometry of the workpiece and the vacuity. In case the vacuity is a channel or an elongate borehole, a metal component is preferably used as Mell, which, upon contacting a corroding medium, is removed to an extent of at least 1 mm per 24 hours, preferably at least 1 mm per 10 hours, in particular at least 1 mm per 5 hours or even 1 mm per hour or even faster. In other words, a metal component is preferred, which dissolves in the longitudinal direction by 1 mm per 24 hours, preferably per 10 hours, more preferred per 5 hours and in particular per 1 hour, in case an elongate borehole is concerned, such that the vacuity “bites into the material” by 1 mm in the mentioned time frame. The inventive carrier material has a compacted structure which may suitably be obtained by a mechanically compacting method. Due to this structure, a combination of interesting properties is obtained, which solves the aforementioned objects.

Surprisingly, it was found out that a placeholder can be removed from the workpiece by using an electro-chemical corrosion reaction.

In the present description, “corrosion” refers to any electro-chemical reaction of a metal Mell with a liquid, corroding medium in the presence of a metal Mel or a metal component containing Mel having a standard electrode potential higher than Mell, which results in an extensive or complete dissolution of Mell while forming gas. A liquid containing ions is referred to as the corroding medium, which dissolves the Mell based on an electro-chemical reaction in the presence of Mel.

The term “standard electrode potential” always relates to the standard electrode potential of a metal or metal component under reaction conditions (with respect to temperature, pressure, type and amount of ions in the solution etc.) and not to its position in the electrochemical series.

The electro-chemical reaction of Mell and the corroding medium occurs in presence of an additional metal component Mel. The term “metal component” refers in particular to metals or metal alloys which promote the corrosion reaction.

According to the invention, a combination comprising a corrodible metal and at least one additional metal component, which may be but does not have to be corrodible, is used, which loses its structure very fast when being in contact with a corroding medium, such as water or an aqueous medium, wherein at least the corrodible metal dissolves and the other present metals possibly remain at least partially in the form of particles. The inventive material features a structure which combines interesting characteristics. On the one hand, the material offers a sufficient strength to function as a placeholder in many different methods, which placeholder can also resist a mechanical stress which e.g. is generated during moulding and/or processing. On the other hand, the material dissolves very fast when in contact with a corroding medium.

These properties, on the one hand, result from the metallic and mechanic properties of the metals and, on the other hand, from the corrosion ability of the material under specific conditions.

Without being bound to a theory, it is assumed that due to a mechanically stressing processing of the inventive carrier material, which e.g. occurs during the moulding of the placeholder, e.g. a compacting, the oxide layer or hydroxide layer protecting the corrodible metal is disturbed such that during a subsequent contact with a corroding liquid, the metal particles or the structure are attacked very easily, which results in a faster corrosion. On the other hand, the additional, more precious metal is brought into such a tight contact with the corrodible metal by the compacting processing, that the corroding reaction can occur very fast.

It was found out that a compacted mixture or alloy comprising at least two metals or metal components, Mel and Mell, the electro-chemical standard electrode potentials of which are different under reaction conditions, is an ideal carrier material for moulding a lost core, wherein at least one of the metals is corrodible by at least 35%, preferably at least 55% and particularly preferred at least 70% upon contact with a liquid corroding medium under defined conditions within a predetermined time period which may e.g. be 30 minutes to 10 hours. As explained above, the removal of the less precious metal Mell depends on the geometry of the workpiece and the vacuity.

In other words, a metal component is preferred, which dissolves in the longitudinal direction by 1 mm per 24 hours, preferably per 10 hours, more preferred per 5 hours and in particular per 1 hour, in case an elongate borehole is concerned, such that the vacuity “bites into the material” by 1 mm in the mentioned time frame or even faster.

In other words, the invention utilizes an electro-chemical reaction to dissolve a compacted mixture comprising a less precious, corrodible metal and at least one more precious metal with the desired speed by contacting same with a corroding medium, generally water or an aqueous medium. This reaction is particularly strong when a solution containing a high amount of ions is used. This corrodibility, which is known per se, is utilized in the invention to remove a carrier material after completion of the workpiece in a simple manner and relatively environmentally sound.

For this purpose, the carrier material is brought into contact with a corroding medium after completion of the workpiece, wherein at least the corrodible metal is dissolved and the not-dissolved carrier material together with the medium containing the corroded metal is subsequently rinsed from the formed mould.

Without being bound to a theory, it is assumed that the compacting of the metal components produces a material, the particles of which have sufficient contact in order to promote an electro-chemical reaction. Simultaneously, the protecting layer surrounding the particles is possibly broken by stress or deformation to an extent that the reaction can take place and is not blocked. In any case, it was determined that in case the metal powders are present in a compacted form, the dissolution is achieved with the desired speed by means of a corroding medium, generally water or an aqueous medium. The inventive carrier material, in particular, enables that the speed of the dissolution reaction can be adjusted selectively. In case, however, powder mixtures having a high porosity are used, which soak when water is added, this may result in a reaction which cannot be controlled.

According to the invention, it is thus preferred that a material is used, the porosity of which is not higher than 20% by volume, preferably not higher than 5% by volume. In a particularly suitable embodiment, the porosity is lower than 1%.

If an inventive material, i.e. a mixture or alloy containing a corrodible metal and a metal component being more precious compared thereto, which was previously compacted, is brought into contact with a corroding medium, preferably a conductive aqueous medium (containing ions), under defined conditions, the corrodible metal is dissolved at least to a large extent. According to the invention, this effect is used to remove a carrier material after completion of a workpiece, by bringing the mixture into contact with a corroding medium and subsequently rinsing the carrier material and the medium from the formed mould.

The difference between the standard electrode potentials may occur in a basic and/or neutral and/or acidic solution, depending on the conditions to which the carrier material is exposed when in contact with the corrodible medium.

In this way, the invention enables to use a material having a high mechanical load capacity as the carrier material and that same is easily removable after completion. This material can be used in many ways, in particular as a lost core for the most different methods. The inventive carrier material is particularly suitable for the production of workpieces having recesses, notches, undercuts and cavities, in particular for producing hollow bodies or workpieces with undercuts by using thermal spraying methods.

The speed of dissolution depends on different parameters or the adjustment of defined conditions, respectively, such that it is possible to use standard means for finding and using the respectively optimum material or the optimum conditions. The parameters influencing the dissolution are i.e. the temperature, the combination of metals, the type and amount of the ions contained in the medium used for the dissolution, surface ratios and mechanical load of the surfaces as well as the hydrogen overvoltage.

The temperature is an important parameter, since the reaction is the faster the higher the temperature. The electro-chemical reaction of the metals with water is exothermic. The speed of the dissolution may therefore be adjusted by controlling the temperature of the reaction, if required or desired. Consequently, the reaction can be adjusted by supplying heat and/or possibly by discharging heat. In the most simple case, the supplying and discharging of heat is performed by using a correspondingly tempered medium as the solvent.

Another important parameter is the combination of the metal components used in the carrier material. It is essential for the invention that at least one metal Mell being corrodible under defined conditions and a corresponding, more precious metal component Mel promoting the corrosion are contained. According to the invention, an alloy or a mixture comprising at least two metal components having different standard electrode potentials is therefore used. Depending on the selected metals, the reaction of corroding the Mell is stronger or weaker. By selecting the additional metal component(s), the speed of the dissolution can thus be influenced.

The corrosivity can be increased if at least one additional metal component which is more precious compared to Mell, i.e. which has a higher standard electrode potential than Mell under reaction conditions, is added to the alloy or mixture. Each metal or each metal component, which has a higher standard electrode potential than Mell and promotes the electro-chemical reaction, is therefore suited as the inventive carrier material. It was found that the metals iron, nickel and copper, in particular in combination with magnesium, have a particularly strong influence on the corrosivity, which metals are therefore preferably used in the inventive carrier material, either alone or in combination as Mel, preferably with magnesium as Mell. A combination of magnesium and iron is particularly preferred.

Another important parameter is the mechanical stress on the carrier material. The inventive carrier material is made of at least two metal components by compacting. It was found out that the corrosion advances very fast when the material and thus the individual particles are strongly stressed prior to or during the moulding. Without being bound to a theory, this may be a result of the fact that possibly existing hydroxide or oxide layers, which protect the corrodible metal Mell, are disturbed or destroyed due to the stress, such that the corroding attack may then occur faster and stronger.

It has been proven to be particularly suitable to process the at least two metal components, preferably in the form of their powders, by thermal spraying. When being processed with thermal spraying, the individual particles are compacted and therefore brought into a very tight contact. Consequently, this method step is particularly suitable.

Another parameter, which can accelerate the corrosion reaction, is the proportion of ions and the activity of the ions which are contained in the corroding, preferably aqueous, medium which is used for the dissolution. It was found out that the corrosion and therewith the dissolution of the metal Mell occurs the faster, the more active anions are available. In this context, i.e. chloride, nitrate and sulphate ions are particularly reactive. Such ions result in a formation of easily soluble salts which accelerate the dissolution, when in contact with various metals.

The corrosion reaction is also influenced by the conductivity of the corrodible, preferably aqueous solution which in turn can be influenced by the proportion of ions. An aqueous medium having a high conductivity or a large proportion of ions results in a fast dissolution. Therefore, aqueous media having a large amount of ions are preferably used for the dissolution. Most preferred, a solution containing sodium chloride is used due to its availability and cost-effectiveness. Sea water is e.g. a very suitable medium. For economic and environmental reasons, also ion-containing wastewater from other processes is very advantageous, which can be recycled very well in this manner.

Another parameter influencing the corrosion reaction is the surface ratio of anodic particles to cathodic particles and the distance between anodic and cathodic particles. The small distance between the anode and cathode can be obtained by the compacting processing which generates the structure of the inventive carrier material, as well as the adjustment of the ratio between Mell and Mel.

Another parameter, which influences the dissolution speed and the progress of the reaction, is the motion of the medium. If the medium is moved after starting of the reaction, the formation of a continuous coating layer made of hydroxides or oxides above the particles of Mell is hindered, such that the corrosion is again further promoted.

The corrosion is also influenced by the hydrogen overvoltage, in particular with regard to the corrosion of magnesium. It was found out that some metals having a lower hydrogen overvoltage are effective cathodes. Therefore, they are preferably used as Mel in order to promote the reaction. Metals having a low hydrogen overvoltage include nickel, copper and iron, which are therefore preferably used, in particular in combination with magnesium.

According to the invention, it is therefore possible to adjust the progress of the reaction dissolving the corrodible metal selectively by adjusting the aforementioned parameters. Therewith, the speed can be adapted to the process, wherein one or more of the aforementioned parameters can be adjusted.

For explaining the production of a workpiece with the inventive carrier material, reference is made to the spraying method, without limiting the invention thereto. Due to its excellent mechanical and chemical properties, the inventive carrier material is applicable for moulding methods of any kind. The inventive material in particular stands out due to its mouldability, machinability, formation of layers with true contours, imaging properties and compatibility with other materials. It can be used in particular when moulds are formed by structuring layers which are then mechanically post-processed for forming simple and complicated, and also delicate bodies which function as placeholders for any kind of vacuity, including undercuts, in materials of any kind. Complicated or delicate moulds can be formed from the material by mechanical processing, normally machining. The layers formed by the inventive carrier material maintain the contours of the substrate onto which they are applied and adhere thereto. Therefore, the inventive material can be used in many ways.

When workpieces having a cavity are produced by spraying, the body is structured by layers and the inventive material is applied in regions which are intended to form the cavity later on, which material can be rinsed away after completion of the workpiece.

Even if “real” alloys are concerned, the compacting is important. Alloys are materials made of at least two components and including at least one metal, wherein the second component of the alloy is either dissolved in the metal or homogeneously distributed in the metal, or is only dissolved to a limited extent such that an alloy enriched second phase is obtained. In any case, inter-metallic compounds are concerned if the second or further components of the alloy are also metals, i.e. atoms of the one metal are included into the matrix of the other metal. The macroscopic properties of the alloy differ from those of the individual metal powders. According to the invention, it is essential that a compacted material is used, since this offers the reactivity and close contact which are required for the corrosion reaction.

The inventive carrier material contains at least two metal powders Mel and Mell, the essential characteristic of which is that their standard electrode potentials are different. The potential difference is at least 0.4 and preferably more than 1. Due to the potential difference, the addition of water or an aqueous medium results in a redox reaction which has the effect that the less precious metal is dissolved. Since the solution generally becomes more basic due to this reaction, the two metal powders Mel and Mell, when in a basic and neutral solution, should feature a different standard electrode potential compared to Mell. For the dissolution, also an acidic aqueous medium can be used, such that the reaction then occurs in the acidic pH-range and the standard electrode potential has to be determined upon an acidic pH-value.

For removing the carrier material, the invention uses this difference between the standard electrode potentials, i.e. with other words the redox reaction underlying the corrosion or dissolution of a less precious metal. For this purpose, two metal components, one of which is more precious and the other of which is less precious, are combined such that a metal mixture is produced which is then compacted such that it has a mechanical load capacity.

In addition to the two metal components, a third component can be present which adds a further desired property. Said component can be selected from many different materials, with the reservation that it neither disturbs the formation of the structure nor the electro-chemical corrosion thereof. For example, an additional material being inert with respect to the electro-chemical reaction can be added, which influences the mechanical properties; for example, a harder material can be added as the third component to enhance the adhesion during the kinetic compacting. Further, it is also possible to add a material catalysing the electro-chemical reaction as a further component, in order to influence the beginning and/or progress of the reaction. In case a third component is used for the inventive carrier material, its content should not exceed 25% by volume. The respectively best suitable amount can be determined by the skilled person by routine experiments. The content must not be so large that it disturbs the formation of the structure and the progress of the reaction. On the other hand, the amount must be sufficient to obtain the desired effect.

The metal powders forming the inventive material are variable in view of their grain size and grain shape. The shape of the particles is uncritical, spherical as well as flake shapes or other forms can be considered. The particle size is uncritical, with the reservation that the particles must not be larger than the vacuity to be filled. Preferably, the particle size is less than 0.5 mm. Particularly preferably, the particle size is less than 0.25 mm.

The dissolution behaviour can also be influenced by the particle size of the two components, such that the optimum material for each application can be chosen by routine experiments. Further, the compacting behaviour and the structure can be influenced by the selection of the particle sizes of both powders and their ratio. Therefore, the particle size can be chosen selectively for one powder or both of them such that the desired characteristics in view of structure and dissolution are obtained.

As soon as the workpiece is finalized, water or an aqueous solution is added, which effects the beginning of a redox reaction with which the less precious metal Mell is oxidized, and hydroxide ions and simultaneously hydrogen are generated. Therewith, a part of the carrier material is dissolved, its structure is destroyed and the particles of the not-dissolved, more precious metal are released. These particles are then rinsed away together with the solution which contains the less precious metal in a dissolved state. Due to the formation of gas, a sufficient motion is generated to keep the reaction going, even if narrow channels or delicate cavities are concerned.

In the inventive electro-chemical reaction, the pH-value may be shifted to the acidic or basic region, depending on the material and medium used. In case a material being easily corrodible is used for producing the workpiece, same can be protected by selecting the carrier material and/or the medium accordingly. For example, the generation of a basic solution is advantageous if the material forming the mould is steel, since the basic solution in this case quasi acts as a rust protection. In case of other materials, a slightly acidic pH-value, which can be obtained by the used medium, may be preferable.

According to the invention, a carrier material is thus provided which is not completely dissolved, but the structure of which is destroyed when being in contact with water, since only a portion is dissolved, which, however, is sufficient to rinse the complete material. For this purpose, at least two metal components are required, which are preferably used in a possibly pure form. Preferably, both components are metals and present in pure form. Pure in the context of the present invention means that the powders mainly comprises a metal and contain at most small portions of impurities or alloy components or small portions of oxides or other compounds resulting from the production or processing steps. It was found out that the best results could be obtained if both metals are present as particles in a compacted structure after application. Such a structure is e.g. generated by thermal spraying, kinetic compacting or cold gas spraying. Herewith, a structure is obtained in which the particles are not molten, but form a densified matrix. Preferably, the material applied by such kinetic spraying has a porosity less than 20%, particularly preferred less than 5% and more preferred less than 1%. If the porosity of the material and therewith the proportion of open pores becomes too large, the carrier material might soak with the aqueous medium and, dependent on the reaction conditions and reactants, dissolve so fast that an uncontrolled reaction with a high gas pressure would result, which is not desired. Besides, the removal of the not-dissolved particles may be disturbed due to an increase of volume of the hydroxide.

Ideally, the matrix made of the two metals is so dense that the surfaces of the particles have sufficient contact to promote the electro-chemical reaction when a corrodible liquid is added.

The two metal components used for the carrier material need to have different standard electrode potentials in order to enable the electro-chemical reaction effecting the dissolution of one component. The standard electrode potential is herein considered under the conditions present at the place of the reaction, e.g. in a neutral, acidic or basic aqueous solution. It may be advantageous if the two used metal components have a difference between the standard electrode potentials of at least 0.4, preferable more than 1, upon reaction conditions.

The selection of the two metal components depends on the differences between their standard electrode potentials and on the aforementioned parameters as well as their reaction ability, which is i.e. influenced by the oxide formation, but also depends on their availability. Besides the economic efficiency, also the eco-friendliness may be considered for the selection. Preferably, those metals are used which are easily available and the disposal of which does not make any problems.

As the more precious metals, in particular copper, iron, tin and nickel are considered due to their availability and their electro-chemical properties. In a further embodiment, metal powders can be used as the metal Mel, which comprise particles which are encased by a precious metal, whereas the core may be made of any material. Possibly, the core material may then provide mechanical properties which the precious metal does not provide. For such an encasing of particles, e.g. gold, platinum, silver, copper, iron or nickel etc. are suitable.

The less precious metal Mell may be any metal having a lower or more negative standard electrode potential compared to Mel. Preferred are magnesium, aluminium, zinc, tin and iron. A combination of magnesium and iron has proven to be particularly suitable.

In a preferred embodiment, a combination of iron and/or copper and/or nickel as Mel and magnesium as Mell is therefore used.

The two metal powders are used in amounts which ensure that the electro-chemical reaction proceeds in the desired scope. When adding a corroding medium, e.g. an aqueous medium, the less precious metal is dissolved at least partially, while the more precious metal remains as powder. Therefore, the less precious metal must be present to such an extent that its dissolution dissolves or destroys the structure formed previously by compacting to such an extent that the generated material can be rinsed away.

If the amount of Mel is too large in this combination, it is difficult to remove the carrier material. On the other hand, the proportion of Mel should not be too little, such that the electro-chemical reaction may proceed sufficiently fast. Preferably, the metal powders are combined in a volume ratio of Mel vis-à-vis Mell between 1:250 and 10:1, preferably from 1:5 to 10:1, and particularly preferably 3:1 to 1:3. Particularly preferred, the metal powders are combined in approximately equal volume proportions (Mel:Mell).

Upon contact with the corroding medium, the structure dissociates by dissolution of the proportion of Mell, which has the effect that the carrier material can be rinsed away. For this purpose, a corroding liquid, i.e. any corroding medium, can be used. The corroding, preferably aqueous medium is uncritical and any medium comprising mainly of water is suited for this purpose. It has to be taken care that no substances affecting the electro-chemical reaction are contained in the water. Preferably, an aqueous medium is used which promotes the electro-chemical reaction, in particular a solution containing ions. Suited are acidic, neutral and basic solutions containing ions, e.g. salt solutions. Diluted acids or bases may also be used. Since the ions contained in the salt solution are not relevant, also a medium containing ions, which is obtained as wastewater, is suitable. This is preferred for environmental and economic reasons. Therefore, tap water as well as wastewater from other processes, which is preferably containing salt, can be used, as long as the redox reaction is not affected.

Another subject-matter of the invention is a method for producing a workpiece having at least one recess, in which the space forming the vacuity is filled with a carrier material which is rinsed away after completion, wherein the carrier material is a material as defined in claim 1.

It has proven that the inventive carrier material is very well suited to form a lost core for a moulding method, with which workpieces having at least one vacuity are formed. The inventive carrier material stands out by its mechanical load capacity, such that it can be used at any place where a material having a mechanical load capacity is required. In addition, it can be processed by a shaping process, in particular a machining process, to form complex shapes.

The inventive carrier material is particularly suited for a processing by means of kinetic compacting or cold gas spraying.

Particularly preferred, the inventive material is used for a method for producing moulds, in which a layer-wise structure is formed by thermal spraying, wherein the layers are then post-processed by machining.

According to the invention, a method for producing a workpiece is thus provided, in which a structure is generated by thermal spraying, wherein portions which are intended to form a recess in the final body are formed by the inventive carrier material, wherein the carrier material is removed upon contact with an aqueous medium after completion of the workpiece.

The inventive carrier material may also be used for other methods, but it is particularly preferred for methods using thermal spraying. Preferably, the thermal spraying is performed by kinetic spraying, wherein the particles are substantially not molten.

Surprisingly, it was determined that the inventive carrier material is very well suited to form lost cores. It can be processed to form various shapes. After completion of the workpiece, the matrix generated upon application of the material is destroyed by an electro-chemical reaction upon contact with an aqueous medium, and due to the motion resulting from the gas formation during the electro-chemical reaction, a sufficient water replacement occurs, in order to promote the electro-chemical reaction in an appropriate manner. The powder of the more precious metal remaining after destruction of the matrix may then be rinsed away easily together with the resulting solution and may possibly be recycled.

The electro-chemical reaction and thus the dissolution of the less precious metal and the destruction of the structure can be promoted in a preferred embodiment by generating a motion of the medium during and after adding the aqueous medium. This may e.g. be performed by rinsing, moving the workpiece or by an ultrasound treatment.

According to the invention, a carrier material is provided which offers an ideal combination of properties due to its mechanical load capacity as well as ductility and its electro-chemical reactivity. In addition, a method is provided with which also very complicated shapes can be produced, since it is possible to build-up the workpieces in layers by spraying methods and to subsequently form even complicated recesses, cavities, notches, openings, undercuts or other unfilled portions by rinsing away the carrier material.

Surprisingly, it was found out that the aforementioned inventive material is very well suited for any kind of placeholder. Due to the advantageous mechanical and electro-chemical properties, the inventive carrier material can be used in case it is required to keep free a space for a certain period of time and to remove the placeholder material subsequently. In particular, the inventive carrier material is suited if the placeholder is mechanically stressed in its function, e.g. is exposed to stress. Except for the aforementioned use for producing a workpiece having cavities, the inventive carrier material may therefore also be used as a lug, spacer, placeholder and lost core in any form.

For this purpose, it is particularly preferred to use a combination of magnesium and at least one of metals iron, nickel or copper. Especially these combinations feature an optimum combination of mechanical load capacity and corrosivity. The combination of magnesium and iron is particularly preferred, since an aqueous suspension is obtained upon dissolving the carrier material, which comprises only magnesium or its decomposition product obtained by corrosion and iron as metals. This combination is non-polluting and can be either disposed easily as wastewater without damaging the environment or be recycled. In case other metals are used in addition to iron or instead of iron, it may be required to recycle the resulting solution before disposing.

The mechanical properties and the environmental acceptability of the product generated after dissolution contribute to the fact that the inventive carrier material is particularly advantageous.

As already explained above, the inventive carrier material, which comprises magnesium and at least one additional metal component which is selected from iron, nickel and copper, is compacted by a mechanically stressing method. The same methods as explained above and the same proportions of the components as explained above are also applicable for the use of the carrier material in general as placeholder. Also the removal of the placeholder is performed in the same way as explained above, i.e. with an aqueous solution containing ions, in particular an aqueous medium containing active anions. Suitable in this context are aqueous media including chloride, nitrate and/or sulphate ions. Due to its good availability, e.g. seawater is a very suitable medium.

1-19. (canceled)

20. A carrier material usable as a placeholder for structuring at least one vacuity of a workpiece, comprising: a compacted corrodible material having at least two metal components, Mel and Mell, wherein the standard electrode potential of Mell is smaller than that of Mel under reaction conditions.

21. The carrier material of claim 20, wherein the Mell and the Mel are combined in a volume ratio between about 250:1 to about 1:10.

22. The carrier material of claim 20, wherein the Mell and the Mel are combined in a volume ratio between about 5:1 to about 1:10.

23. The carrier material of claim 20, wherein the carrier material is compacted by thermal spraying.

24. The carrier material of claim 20, wherein the carrier material is compacted by kinetic spraying or cold gas spraying.

25. The carrier material of claim 20, wherein the carrier material is compacted by pressing or sintering.

26. The carrier material of claim 20, wherein the carrier material is machinable and/or deformable.

27. The carrier material of claim 20, wherein the carrier material has a porosity of less than about 20% by volume.

28. The carrier material of claim 20, wherein the carrier material has a porosity of less than about 5% by volume.

29. The carrier material of claim 20, wherein the carrier material has a porosity of less than about 1% by volume.

30. The carrier material of claim 20, wherein Mel is copper, iron, nickel or tin.

31. The carrier material of claim 20, wherein Mell is magnesium, aluminium, zinc, tin or iron.

32. The carrier material of claim 20, wherein Mel is a metal powder containing particles that are encased with a more precious metal than Mell and have cores formed of any material.

33. A method for producing a workpiece having a body with at least one vacuity comprising:
forming the at least one vacuity with a compacted carrier material comprising two metal powers each having a different standard electrode potential; and
removing the carrier material after completion of the body, without damaging the body, by contacting the carrier material with an aqueous medium and rinsing away a resulting suspension of the carrier material and the aqueous medium.

34. The method of claim 33, further comprising producing the workpiece by kinetic spraying or cold gas spraying.

35. The method of claim 33, further comprising producing the workpiece by sintering and pressing.

36. The method of claim 33, further comprising producing the workpiece by a thermal spraying method.

37. The method of claim 33, wherein contacting the carrier material with an aqueous medium dissolves the carrier material and the speed of the dissolution is adjusted by tempering a corroding medium.

38. Use of a mixture of two metal components, Mel and Mell, wherein the standard electrode potential of Mell is smaller than that of Mel under reaction conditions, for producing a lost mould using a compacting technique.

39. The use of the mixture of claim 38, wherein Mel is iron and Mell is magnesium.
